(19) United States
(12) Patent Application Publication
(10) Pub. No.: US 2006/0130149 A1
(43) Pub. Date: Jun. 15, 2006

(54) Digital rights management microprocessing architecture

(76) Inventor: Shuhua Xiang, Fremont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/187,358

(22) Filed: Jul. 21, 2005

Related U.S. Application Data
(60) Provisional application No. 60/635,114, filed on Dec. 10, 2004.

(51) Int. Cl. H04N 7/16

(52) U.S. Cl. 726/26

(57) ABSTRACT

A system rights management system can process a multi-media data stream. In an embodiment, the system includes digital rights management (DRM) processing modules, shared first in first out (FIFO) buffers, and a cross-bar switch for channeling data between the DRM modules and the shared FIFO buffers. In another embodiment, the system includes an embedded processor, allowing DRM processing tasks to be performed using a dedicated processor rather than tying up the resources of a general CPU.

### CROSS REFERENCE TO RELATED APPLICATIONS

This application claims the benefit of U.S. Provisional Application No. 60/635,114, filed on Dec. 10, 2004, which is herein incorporated in its entirety by reference.

### BACKGROUND

1. Field of Invention

This invention relates generally to the field of chip design, and in particular, to digital rights management architecture for microprocessor applications.

2. Background of Invention

Digital rights management (DRM) has become an integral part of the digital content landscape. Increasingly sophisticated and complex DRM regimes are continually being developed to prevent unauthorized access and copying of digital works such as movies, music, games, and other multimedia. DRM technologies are now a part of virtually all forms of digital content and the equipment and devices used to access the content.

The proliferation of DRM schemes has presented several challenges to hardware makers. The design of chips must be flexible enough to accommodate new DRM technologies and protocols. To keep apace with DRM development, a chip may have to be adapted even after it has been built. At the same time, managing and performing various DRM calculations consumes considerable memory and processing resource, making efficiency a top priority. These parameters must be traded off against security concerns, to prevent exposure of sensitive DRM information to would-be attackers. What is needed is a way to balance competing concerns and provide a robust DRM system for chip design.

### SUMMARY OF THE INVENTION

Embodiments of the present invention provide a novel architecture for supporting DRM protocols in a multi-media system that overcomes the problems of the prior art. In an embodiment, a DRM system comprises a first DRM processing module and a second DRM processing module; a plurality of shared first in first out (FIFO) buffers, and a cross-bar switch for channeling data between the plurality of DRM modules and the shared FIFO buffers. In accordance with a DRM processing algorithm, data is provided from the first processing module to the second processing module through at least one of the shared FIFO buffers. Flexibly, such a system can be adapted for use with various DRM modules. In an embodiment, the system includes a Reduced Instruction Set Computer (RISC) processor. This beneficially allows DRM protocols, which typically require significant memory and processing resources, to be performed using an embedded dedicated processor rather than tying up the resources of a general CPU.

In another embodiment, a data stream is received data stream; a DRM process is performed on the stream, and an output of the process is provided through a cross-bar switch to a multichannel FIFO. In an embodiment, the DRM process may represent any of a variety of processes such as a parsing process, an AES process, a DES/3DES process, a RC4 process, a MBC process, a CSS process, an encryption process, a decryption process, or a security process. After the process is complete, a second module receives the output from the FIFO, and the output is processed.

### BRIEF DESCRIPTION OF THE DRAWINGS

The accompanying drawings illustrate embodiments and further features of the invention and, together with the description, serve to explain the principles of the present invention.

FIG. 1 depicts a high-level block diagram of a DRM system in accordance with an embodiment of the invention.

FIG. 2 depicts a block diagram of an exemplary DRM system in accordance with an embodiment of the invention.

FIG. 3 shows a process flow for configuring a DRM system in accordance with an embodiment of the invention.

FIG. 4 shows a process flow for operating a DRM system in accordance with an embodiment of the invention.

### DETAILED DESCRIPTION OF THE DRAWINGS

The present invention is now described more fully with reference to the accompanying Figures, in which several embodiments of the invention are shown. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

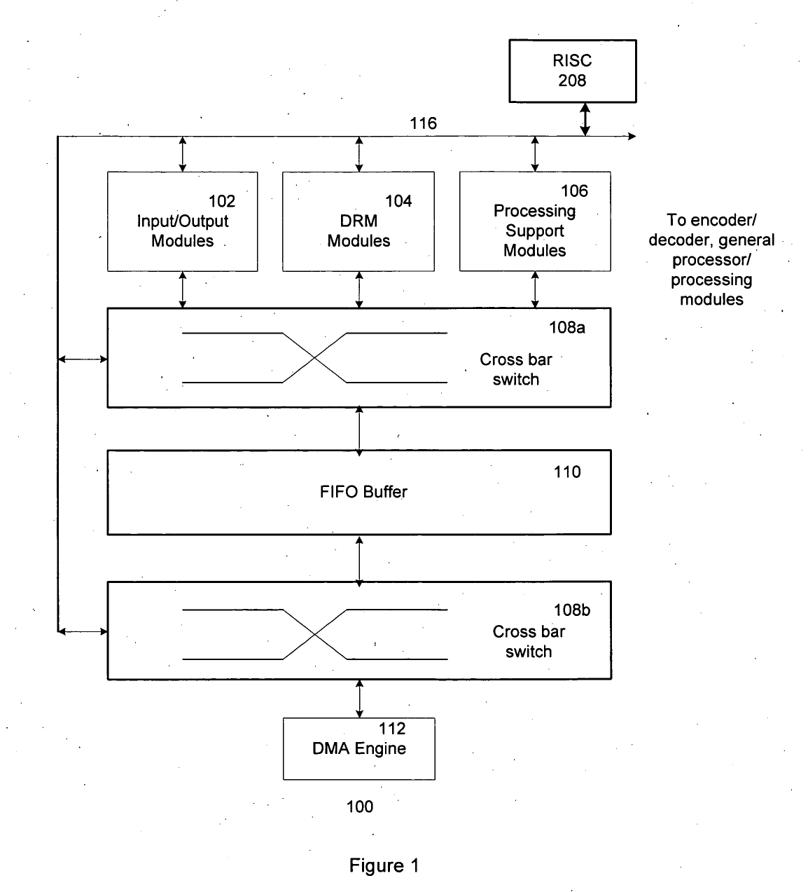

FIG. 1 depicts a high-level block diagram of a DRM system 100 in accordance with an embodiment of the invention. The system includes several DRM modules 104, processing support modules 106, a RISC processor 208, a shared FIFO buffer 110 comprising a set of individual buffers, and two cross-bar switches 108, one on either side of the shared buffer 110. These components are coupled to each other through a dedicated bus 116. As the system 100 processes video and audio data in accordance with various digital rights management protocols, data and requests are generated by the DRM and support modules 104, 106. The data and requests pass through the first cross-bar switch 108a to the FIFO buffer 110 and from there are routed to any of a variety of destinations. The data may go through the second cross-bar switch 108b and be provided to a DMA engine 112, for instance. Or, the data may be provided from the FIFO 110 through the first cross-bar switch 108b directly to another DRM module 104 or a processing support module 106 for further processing. Or, the data may be provided to and returned from one or more input/output modules 102 for further processing.

This architecture has several advantages. Data generated by a DRM or processing support module 104, 106 whose destination is another such module in effect can be routed directly from one module to another through the shared FIFO 110 or DMA engine 112. That makes processing faster and more efficient, avoiding the need for data to pass through a CPU and the interrupts associated with prior art per packet processing. In addition, the shared FIFO buffer 110 provides a common resource that can be used by a plurality of modules 104, 106 and allows for dynamic allocation of system resources and access by the cross-bar switches 108. Furthermore, by allowing DRM processes which are typically processing intensive to travel over a dedicated 116 bus rather than having to rely on shared system bus, the architecture mitigates bus contention issues, further enhancing system performance.

The DRM system 100 of FIG. 1 could be used in any of a variety of contexts including a Very Large Scale Integration (VLSI) architecture that also includes a general processor and a DMA/memory. This or another architecture may include an encoder and/or decoder system that conforms to one or more video compression standards such as MPEG1, MPEG2, MPEG4, H.263, H.264, Microsoft WMV9, and Sony Digital Video (each of which is herein incorporated in its entirety by reference), including components and/or features described in the previously incorporated U.S. application Ser. No. 60/635,114. A video, audio, or video/audio stream of any of a various conventional and emerging audio and video formats or compression schemes, including .mp3, .m4a., wav., .divx, .aiff, .wma, .shn, MPEG, Quicktime, RealVideo, or Flash, may be provided to the system 100, processed, and then output over a bus for further processing, transmission, or rendering. The data can be provided from any of variety of sources including a satellite or cable stream, or a storage medium such as a tape, DVD, disk, flash memory, or smart drive, CD-ROM, or other magnetic, optical, temporary computer, or semiconductor memory. The data may also be provided from one or more peripheral devices including microphones, video cameras, sensors, and other multimedia capture or playback devices. After processing is complete, the resulting data stream may be provided via an output module of the input/output modules 102 to any of a variety of destinations including an encoder or decoder, general processor, or other processing, rendering, or output module. The DRM system 100 may be implemented in any of a variety of ways. In an embodiment, it comprises a dedicated system on chip (SOC) for use in any of a variety of contexts. The dedicated BUS 110 and input/output modules 102 allow for transmission o data between the DRM system 100 and off-chip modules, processors, and encoder/decode engines. It may also comprise a subsystem of a dedicated encoding or decoding system, or be integrated into the hardware system of a device for recording, rendering, storing, or processing audio, video, audio/video or other multimedia data.

Each DRM module 104 contains logic for performing various cryptography and processing functions. An individual module 104 may be configured to implement any of a variety of DRM protocols including AES, DES/3DES, RC4, MBC, CSS, all of which are herein incorporated in their entirety by reference, or any of a variety of existing or emerging cryptography (decryption), security, or other such regimes. As processing is carried out according to one or more of these protocols, particular tasks may be outsourced to one or more processing support modules 106. Data generated by the DRM module 104 or received by an input module 102 is provided over the BUS 116 to a processing module 104, which performs one or more dedicated processing tasks. The result of processing by the processing module 104 may then provided back to one or more DRM modules 104 or another destination.

The input/output modules 102 comprise interfaces for receiving and transmitting data to various modules and subsystems outside of the DRM system 100 In an embodiment, the DRM system 100 comprises a system on chip (SOC) and the input/output modules 102 provide a gateway to one or more general or dedicated processors for performing off-chip processing. This makes it easy to adapt an existing chip to support new capabilities outside of the constraints of the existing chip design. In addition, raw or processed data to be processed by the DRM system 100 may be provided from external subsystems through one or more input module 102, to later be transmitted via an output module 102 to an off-chip destination.

The shared FIFO buffer 110 comprises a series of individual first in first out memory modules for temporary data storage and are used for buffering transmit and receive data. In an embodiment, the shared buffer 110 comprises eight FIFOs, four each for transmitting and receiving. Each set of four FIFOs consists of 32 bits of data and four status flags. The receive FIFOs are loaded by control logic in the DRM system 100 and read by either a general processor or the DMA engine 112. In an embodiment, the FFIO buffer is stored in Static Random Access Memory (SRAM) in order to allow for fast processing and implementation of DRM algorithms.

Each cross-bar switch channels data between modules and components attached to it up to its maximum number of ports. In an embodiment, one or more paths are pre-configured according to DRM modules 104 and processing algorithms. Alternatively or in addition, the data paths do not need to be fixed, but can be changed as dictated by processing needs. As shown in FIG. 1, the first crossbar switch 108a couples various input/output modules 102, DRM modules 104, and processing support modules 106 to the shared FIFO buffer 110, while the second crossbar switch 108b couples the shared FIFO buffer 108b to the DMA engine 112. As known to one of skill the art, however, the cross-bar switches 108 may comprise one to one, multiple to multiple, or one to multiple cross bar switches, arranged in various configurations. In an embodiment, each of the various functional blocks 104, 106 has an input interface, an output interface, and a bus 116 interface. Through the cross-bar switches 108, any given block 104, 106 can read data through its input interface from the DMA engine 112 or FIFO buffer 110. Likewise, through the output interface, a block 104, 106 can write into a DMA engine 112 or FIFO buffer 110.

Data from the second cross bar switch 108b may be provided to the FIFO buffer 110 or to the DMA engine 112. In an embodiment, the DMA engine 112 can read and write to the FIFO and is coupled to a memory of the host processing system into which the DRM system 100 is integrated and can write to the memory without passing the data through the host CPU. As such, the DMA engine 112 allows DRM data to be quickly transmitted by the DRM system 100, and requires minimal intervention from the host.

The system 100 also includes a dedicated bus 116 for transmission of data between the various system components shown. Because the data never passes through a general bus, where plain text transmission may be intercepted, the related security exposure is minimized, enhancing the overall security of the system. In an embodiment, the bus 116 comprises a proprietary control bus made by WIS Technologies of Santa Clara, Calif. including an interface for a general processor to access information of the DRM system 100.

Data flows between various components of the DRM system 100 are controlled by the RISC processor 208 through the bus 116. In an embodiment, the RISC processor 208 comprises an embedded processor dedicated to the DRM system 100 that controls data flow in the DRM system 100 and performs DRM processing functions. The processor 208 may also comprise a proprietary 16-bit XML RISC processor. In an embodiment, the RISC 208 sets the keys for processing and carries out other sensitive processing functions. Because the processor 208 is embedded in the DRM system 100, this decreases overall system vulnerability to external attack.

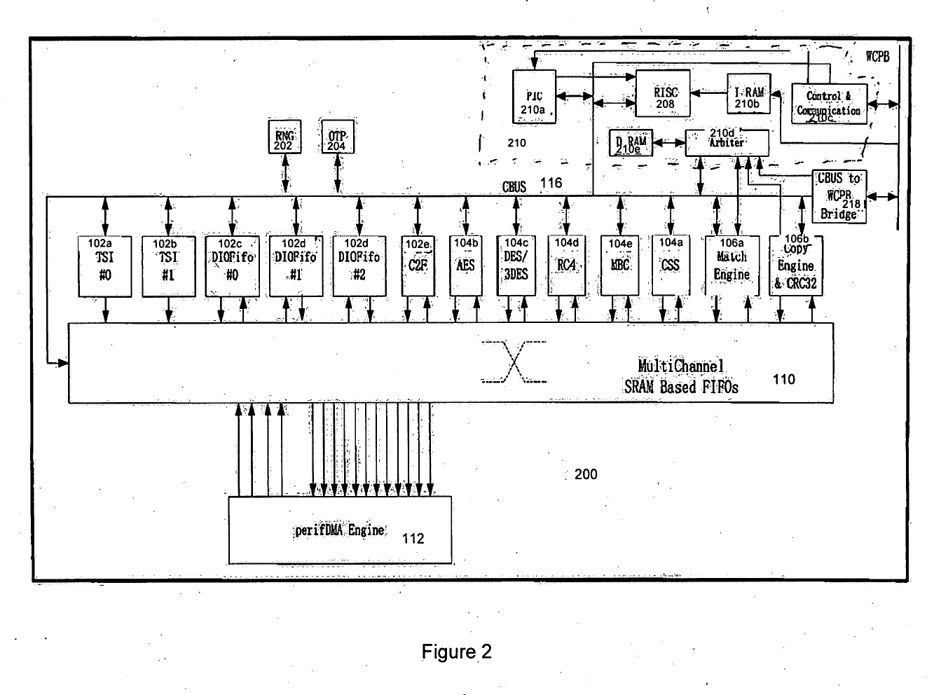

FIG. 2 depicts a block diagram of an exemplary DRM system 200 in accordance with an embodiment of the invention. As shown, the system 200 elaborates upon the architecture of the system depicted in FIG. 1 and adds several features to improve upon system security, adaptability, and performance. As shown, the system 200 includes a RISC processor 208 and processor subsystem comprised of subsystem modules 210, DRM modules 104, several input/output modules 102, and DRM support modules 106. These elements are connected by a certified bus 116 to a bridge 218 that is coupled, in an embodiment, to other processing modules (not shown). The system 200 has several embedded modules for performing sensitive tasks in a secure setting including a random number generator (RNG) 202, and one-time programmable memory (OTP) 204.

The input/output modules 102 comprise interfaces for providing incoming and outgoing streams to and from the DRM system 200. In an embodiment, the modules 102 comprise transport stream input (TSI) interfaces 102a, 102b for providing encrypted content to the DRM system 200. In an embodiment, the two TSI blocks 102a, 102b can process two transport streams simultaneously, and include FIFO interfaces that can be used to perform various application-specific functions such as providing NRSS-A (one bit input and one bit output) interfaces or teletexting output for a TV encoder. Also included are direct FIFO interfaces 102d for transmitting data to an off-chip processor. Such an architecture allows the DRM system 200 to be easily extendable and encompass processing capabilities beyond the existing chip.

Also included are direct FIFO modules 102d and certified bus to FIFO (C2F) interfaces 102e to enable access by one or more general or specialized processors separate from the DRM system. In an embodiment, the C2F 102e bridges the bus 116 to the FIFO 110, enabling the RISC processor 208 to directly read and write to any of the FIFO buffers 110. Data may flow to and from the external processing system and the DRM system 200. In an embodiment, data to the external processing system is encrypted before it is sent, and likewise, data from the external processing system is encrypted before it is provided back to the DRM system 200, in order to avoid transmission of DRM data in plain text format. One or more systems or modules for performing encryption or various other security measures may be communicatively coupled to the external processing system in order to implement these security measures.

The DRM modules 104 support various decryption/encryption algorithms. The AES module 104b, for instance, supports both normal (CBC and ECB) and counter modes of the AES algorithm. Similarly, the RC4 module 104d implements the RC4 algorithm, the CSS module 104a performs CSS functions, the Microsoft Block Cipher (MBC) module supports both inverse and normal modes, and the DES/3DES module 104c supports both modes of the DES/3DES algorithm.

The DRM support modules 106 provide functionality to support the various DRM modules 104. In an embodiment, a match engine 106a performs header analysis and carries out functions dictated by the header such as PID matching and section filtering. As known to one of skill in the art, these tasks may be carried out by the match engine 106a in order to find a particular packet/key. For example, a 32-bit input could be compared with a set of 32-bit patterns and a 32-bit mask used to control what bits are compared. The input data can be written by the RISC 208 via the busline 116 or read from one of the input FIFOs 110 directly.

A copy engine 106b moves data between various modules. For instance, the copy engine 106b can copy data between one FIFO buffer 110 to another buffer 110 or from a FIFO 110 to RAM or Dynamic Random Access Memory (DRAM) 210e and vice versa. In addition data can be copied from a source location such as a FIFO 110 or DRAM 210e to “nothing,” thereby dropping some data. The copy engine 106b may also includes CRC32 logic for performing CRC32 calculations on the data. In an embodiment, the copy engine 106b can calculate the CRC32 value of the transferred data using the algorithm shown below:

unsigned int wombat(unsigned char *data, int len)

| | |
|---|---|
| { unsigned int | result; |

| | |
|---|---|
| int | i,j; |
| unsigned char | octet; |

result = −1;
for (i=0; i<len; i++)
{octet = *(data++);

for (j=0; j<8; j++)
{if ((octet >> 7) \hat{ }(result >> 31))

{result = (result << 1) \hat{ }QUOTIENT;}
else
{result = (result << 1);}
octet <<= 1;}}

return ˜result; ·/* The complement of the remainder */}

The system includes several embedded modules 202, 204 to perform sensitive encryption/decryption functions. These modules can only be accessed by the dedicated processor 208 via the bus 116, making them less susceptible to attack and preventing transmission of the values they generate over a general bus. The RNG 202, for example, is embedded into the DRM system 200 and generates cryptography values to populate DRM algorithms as needed. The OTP memory 204 similarly contains device-specific identification information that is unique to each hardware device. The OTP memory 204 may include several memory fields to support various functions such as disable/enable, flash secrete encryption, and user defined secrete individualized information.

In an embodiment, the OTP memory 204 supports AES and WMV9 support enable. The OTP memory 204 may also support flash secrete encryption enable and store an encryption key. With respect to user defined secrete individualized information, in an embodiment, encrypted information is stored in the flash memory of a DRM or other general system, and the decryption key is stored in the OTP 204. Alternatively or in addition, the encrypted information may be stored directly in the OTP 204 for use by the various DRM modules 204, 206. Information stored in the OTP 204 may also be used to initialize firmware in the flash memory. This initialization may be verified by the POST ROM or by the flash code. Similarly, the OTP 204 can store various device values for authenticating the device to a remote host for updating firmware.

The RISC processor 208 is supported by the processor subsystem 210. As shown, the subsystem 210 is comprised of a Programmable Interrupt Controller (PIC) 210a, a DRAM 210e, arbiter 210d, RAM 210b, a control and communication module 210c, and bus to WCPB bridge 218. The PIC 210a controls interrupts on the RISC 208. The RISC 208 sets the keys for processing and controls data flow, according to a DRM instruction set. The instruction set may be downloaded stored by an off-chip processor to the IRAM 210b where it is accessed by the RISC 208 during processing. The control and communication module 210c and arbiter 210d mediate off-chip and on-chip data flows within the DRM system 200 as well as between the DRM system 200 and external systems. The processor subsystem 210 may also include a microprocessor without interlocked pipeline stages (MIPS) (not shown) that may be used interchangeably to perform functions of the RISC 208 as described below. A MIPS processor may complement or substitute for the RISC 208.

The DRAM 210e is accessed by the RISC 208 and other modules in order to carry out processing functions. In an embodiment, the RISC 208 or MIPS, the matching engine 106a, and the copy engine 106b are each configured to access DRAM 210e. In an embodiment, only one of the three can be active (or represent an “active master”) at a time. When the current active master completes its processing job, it hands over the right of accessing to another master. The coordination between masters is performed by the control and communication module 210c. A MIPS can access a particular area in DRAM 210e at any time, however it must share bandwidth with the active master. The arbiter 210d mediates this sharing.

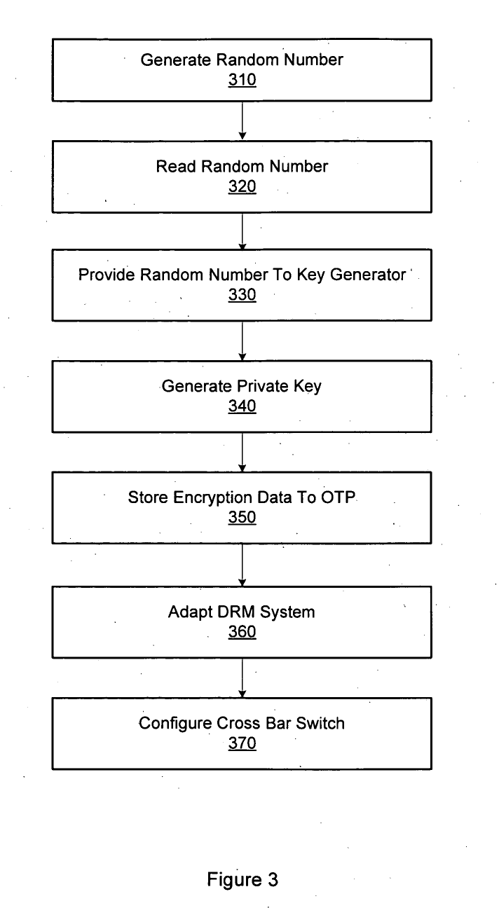

FIG. 3 shows a process flow for configuring a DRM system in accordance with an embodiment of the invention. First, a random number is generated 310 by an embedded random number generator. This value is read 320 by the RISC and provided 330 to a key generator as well as a unique device identifier read from a registry in a OTP memory. These values are used to generate 340 a private key for encryption purposes. The encryption data is stored 350 to the OTP memory to later be retrieved during operation of the DRM system. The DRM system 360 is then adapted to support certain DRM algorithms. One or more cross bar switches is then configured 370 per the processing flow dictated by the algorithms.

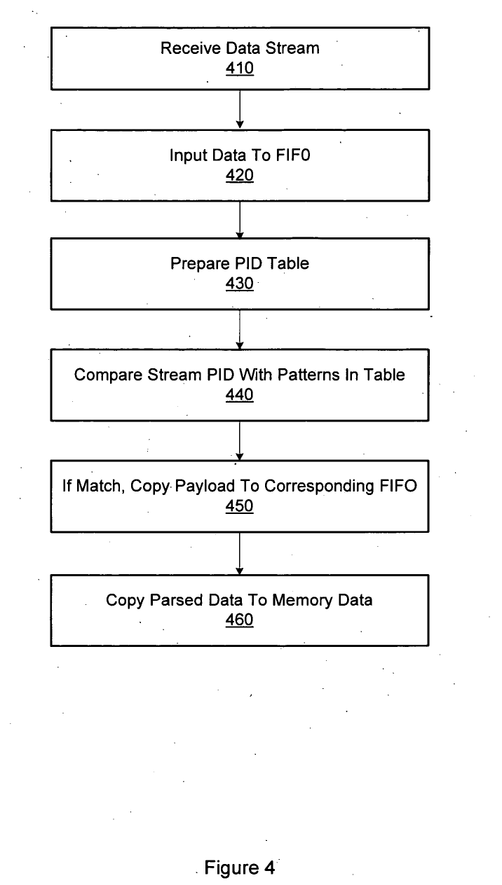

FIG. 4 shows an exemplary process flow for operating a DRM system of in accordance with an embodiment of the invention in which a data stream is parsed. The multimedia data stream is received 410 via a transport stream input interface and input 420 to an internal FIFO, for instance FIFO #12 of a shared buffer that includes individual FIFOs #1 through #12. An entry process ID (PID) pattern table is prepared 430 in DRAM, a controller writing the information via a bridge. Directed by the MIPS, a matching engine compares 440 the input transport stream packet's PID with values in the pattern table that comprises pattern0, pattern1, pattern2, and so on. If there is a match 440 with a particular pattern, and the match is with a particular pattern, the packet payload is copied 450 to the corresponding FIFO. For instance if there is a match with pattern0, the payload of the packet will be copied from FIFO #12 to FIFO #2 by the copy engine and if the match is with pattern, the payload copies to FIFO #3. The parsed data is copied 460 by a DMA engine into specific memory addresses.

Variations on the basic process flow above may easily be made. For instance, to carry out parsing with encryption, an AES module, for instance, may take data from the FIFO designated for storage of encrypted data, decrypts the data, and outputs the decrypted data to another FIFO. Similarly, to carry out parsing with NRSS-A, a Direct-FIFO module working in NRSS-A mode takes data from an internal FIFO after a match has been found. The information is processed and then sent out and looped back to another internal FIFO. The DMA engine then copies the parsed data from the internal FIFO into specific memory addresses.

Other process flows can be used to support various types of decryption algorithms. In support of an AES algorithm, for example a DMA engine may write encrypted sector data into an internal FIFO. The CSS block takes the encrypted sector data from the internal FIFO, decrypts it and writes the decrypted data into another FIFO. The DMA engine takes the decrypted data from the FIFO and writes it to a double data rate (DDR) memory. Or, to perform AES decryption/encryption, the DMA engine writes ciper_text/plain_text into an internal FIFO. The AES module will take data from the FIFO, decrypt/encrypt the data and writes the result into another FIFO from which the DMA engine takes the result. Alternatively, to input data directly to memory, an input transport stream input interface writes the data to an internal FIFO from which the periDMA takes the data and writes it to DDR.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed:

1. A digital rights management processing system, the system comprising:
a plurality of digital rights management (DRM) processing modules including a first processing module and a second processing module;
a plurality of shared first in first out (FIFO) buffers; and
a cross-bar switch for channeling data between the plurality of DRM modules and the shared FIFO buffers, wherein, responsive to a DRM processing algorithm, data is provided from the first processing module to the second processing module through at least one of the shared FIFO buffers.

2. The system of claim 1, further comprising an embedded processor for controlling a data flow between the plurality of DRM processing modules and the plurality of FIFO buffers.

3. The system of claim 2, wherein the embedded processor comprises one of: a RISC processor and a MIPS processor.

4. The system of claim 1, wherein the plurality of shared FIFO buffers is logically coupled to the plurality of DRM processing modules through a dedicated bus.

5. The system of claim 1, wherein the system is coupled to one of: a decoder and an encoder for processing the data stream.

6. The system of claim 1, further comprising one of: a match engine for performing header analysis on the data stream and a copy engine for performing processing in association with at least a DRM module of the plurality of DRM modules.

7. The system of claim 1, implemented in a system on chip.

8. The system of claim 7, further comprising an interface to an off-chip processor for generating data to be provided to the system.

9. The system of claim 8, wherein the off-chip processor comprises an encryption module for encrypting data to be provided to the system.

10. The system of claim 1, further comprising one of: an embedded one time programmable (OTP) memory for storing data and a random number generator module for generating a random number in order to support processing by at least a DRM module of the plurality of DRM modules.

11. The system of claim 1, configured to support DRM processing in accordance with at least one of: an AES protocol, a DES/3DES protocol, a RC4 protocol, a MBC protocol, a CSS protocol, an encryption protocol, a decryption protocol, and a security protocol.

12. The system of claim 1, further comprising a second cross-bar switch communicatively coupling the plurality of FIFO buffers to a processing engine.

13. The system of claim 12, wherein the processing engine comprises a direct memory access (DMA) engine.

14. A method of performing a digital rights management (DRM) process, the method comprising:
receiving a data stream;
performing the DRM process on the data stream;
providing through a cross-bar switch an output of the DRM process to a multichannel FIFO;
receiving by a second module from the FIFO the output; and
processing the output.

15. The method of claim 14, wherein the DRM process comprises at least one of: a parsing process, an AES process, a DES/3DES process, a RC4 process, a MBC process, a CSS process, an encryption process, a decryption process, and a security process.

16. The method of claim 14, further comprising providing the output to an output interface for transmitting to a processor for additional processing.

17. The method of claim 14, further comprising writing the output to one of: a FIFO, a DDR memory, DRAM, and an OTP memory.

18. The method of claim 14, wherein the step of performing the DRM process is performed by one of a matching engine, a copy engine, a DRM module, a RISC processor, and a MIPS processor.
